(19) United States
(12) Patent Application Publication
(10) Pub. No.: US 2026/0004240 A1
(43) Pub. Date: Jan. 1, 2026

(54) STORAGE AND ORDER-PICKING SYSTEM WITH OPTIMIZED MATERIAL FLOW

(71) Applicant: SSI Schäfer IT Solutions GmbH, Friesach (AT)

(72) Inventor: Markus KLUG, Gratwein-Strassengel (AT)

(21) Appl. No.: 19/131,761

(22) PCT Filed: Nov. 20, 2023
(86) PCT No.: PCT/EP2023/082400

§ 371 Date: May 21, 2025

(30) Foreign Application Priority Data
Nov. 24, 2022 (DE) 10 2022 131 101.5

(51) Int. Cl. G06Q 10/087; B65G 1/137; G05D 1/698; G05D 101/10

(52) U.S. Cl. CPC G06Q 10/08741; B65G 1/1373; G05D 1/6987; G05D 2101/10

(57) ABSTRACT

There is disclosed an intralogistics system (10) comprising: a transport network (14) comprising a plurality of transport units (15; 16, 18) and being configured to implement a material flow, caused by transport orders (22), within the intralogistics system (10), wherein each of the transport devices (15) is operated with at least one preset variable operating parameter (36); a plurality of sensors (28) cyclically detecting the current operating states (34); and a controller (26) including a material-flow computer (30), which initially plans and generates the transport orders (22), and cyclically coordinates the implementation of the transport orders (22) based on the current operating states (34); wherein the controller (26) further includes a digital material-flow twin (32), which includes a material-flow simulation model (40), an operating-parameter optimization device (42) and an analysis device (44) and is configured: to cyclically simulate the material flow based on the respective current operating states (34) with and without varying operating parameters (36) of the transport devices (15), to analyze the simulated material flows with regard to throughput improvement, and in case that throughput improvement is analyzed, to transmit the correspondingly varied operating parameter (36) to the corresponding transport devices (15), which subsequently are operated based on the varied operating parameters (36). Further, there is disclosed a method for implementing material flow.

### CROSS-REFERENCE TO RELATED APPLICATIONS

This application is a national stage application under 35 U.S.C. 371 of PCT Application No. PCT/EP2023/082400 having an international filing date of 20 Nov. 2023, which designated the United States, which PCT application claimed the benefit of German Application No. 10 2022 131 101.5, filed 24 Nov. 2022, each of which are incorporated herein by reference in their entirety.

### BACKGROUND

In general, the present disclosure relates to the field of intralogistics, and in particular to an optimized control of material flow in an intralogistics system, such as in a storage and/or order-picking system. The material flow is quasi-continuously coordinated in a throughput-optimized manner by cyclically changing operating parameters of transport devices while initially generated transport orders remain unchanged and are implemented continuously.

In general, the term “material flow” (MF) means a sequence of storage, transport and processing operations. According to VDI 2689, this term is to be understood as all processes and their interlinking in the extraction, processing, as well as distribution of MF objects (handling units such as storage units, workpieces, conveying items, etc.) within fixed functional areas. The areas can include various stations between a (goods) receipt (which can also be implemented by a production facility) and a (goods) issue. MF includes all forms of an MF object passing through an MF system, which corresponds to a transport network in an area between the entrance and exit.

FIG. 8 schematically illustrates conventional material flow, visualized by arrows, from an entrance (reception) to an exit (dispatch) of an intralogistics system 10. Various areas and stations (reception, production, warehouse, picking, consolidation, and/or packing station) are connected to one another via conveying devices. Existing conveying connections are illustrated by solid-line arrows. Further alternative and/or additional connections are illustrated by dashed-line arrows. The entirety of all connections defines a transport network. It is understood that the areas and stations are connectable to each other in a variety of ways, wherein conveyors are used. This is set by a system designer as needed.

MF processes are planned in a conventional material-flow computer (MFC) in terms of corresponding transport orders (in advance), and implementation thereof is coordinated and monitored (in real time). The MFC plans and coordinates corresponding source-destination relationships. The material-flow control caused by the MFC is often also described as (picking) order management assigned to the transport network. However, this general definition of the material-flow control does not do justice to the actual task if an evolved heterogenous structure of performant transport devices, which needs to be coordinated precisely to enable an optimal operation result, exists in the intralogistics system. The material-flow control has a central function. Despite a plurality of different transport devices and expansion stages, it should ensure at all times, for example, the maximum throughput, the fastest possible provision and/or the lowest energy consumption.

The primary task of the material-flow control is to perfectly coordinate the transport orders of the connected areas and stations. The transport devices available must be assigned to transport orders and, in doing so, be utilized without blocking the transport network, if possible. At any point in time, the operating state (e.g., degree of utilization) of the network and the occupancy states of routes, way points, intersections, junctions, and the transport devices are to be considered. The quantity of MF objects and the transport speeds thereof interact with each other.

However, the classic MFC is able to solve MF problems, which occur randomly in reality, to a limited extent only. The MFC cannot anticipate these actually occurring problems when initially generating the transport orders, but only reacts to problem messages that have occurred.

For example, the classic MFC cannot anticipate real and random slippage of a conveying item during transport of the conveying item, e.g. on a belt conveyor, and a throughput deterioration resulting therefrom, or other technical problems. The slippage results in a delayed arrival time at the destination, which was set in advance by the MFC. The delayed arrival can in turn result in that the destination is occupied by another conveying item having arrived in the meantime, or in that a pre-planned sequence does not occur. In this case the classic MFC can only solve situationally the resolution of this conveying-item delivery problem by instructing the delivering belt conveyor, for example, to wait with the delivery, contrary to the original schedule.

Also, driverless transport vehicles (DTVs) may be mentioned as another example. For example, the classic MFC in advance determines (collision-free) transport, or driving, orders for two DTV. During the actual implementation, however, the DTVs then meet each other unexpectedly such that there is danger of collision (e.g., due to delayed departures because of too late clearance of the sensors of the DTV, possible intermediate stops, or reduced travelling motions due to glare or other external influences on the camera technology monitoring the environment, etc.). The DTVs mutually “see” each other by means of the integrated distance sensors thereof and stop for safety reasons. The MFC is informed on both stopping conditions and decides, for example, dependent on the transport priorities being associated with the respectively transported conveying items, which of the DTVs may travel first. During its initial planning of the transport orders, the MFC was not able to predict that, for example, the motor of one of the two DTVs is briefly before the end of its service life, and therefore the corresponding DTV can travel, and travels, at 80% of its rated speed only, for example. In this case, the classic MFC can only react to this problem as the situation arises, and in worst case there is even an (unexpected) system downtime, which can only be resolved by a maintenance technician, who manually intervenes from the outside. This reduces the throughput significantly.

Classic MFCs should be distinguished from classic MF simulations, which are used in the early (project-planning) phase during a design of an intralogistics system and are developed on the basis of historical data without any connection to a real system.

In general, each simulation is based on a (static) simulation model, wherein the model is fed a set of parameters and the result is calculated, or simulated, over time. According to VDI 3633, the term “simulation” refers to the reproduction of a system with the dynamic processes thereof in an experimental model in order to gain insights that can be transferred to reality. In particular, the processes are developed over time. In a broader sense simulation is understood to mean the preparation, performance and evaluation of targeted experiments with a simulation model. However, every model has its limitations (e.g., limited resources, energy, time, money). Therefore, factors that have a minimal influence are often not considered sufficiently accurate in the model so that it often merely represents a rough simplification of reality. The simplifications negatively affect the accuracy of the simulation results. Intralogistics areas and the transport network are combined and simulated in a heavily simplified way. The MF simulation is fed real order data from the past in order to (offline) map the movement of the MF objects as realistically as possible by means of a respective system variant. At the same time capacity, performance and control of the respective system variation are examined for optimization possibilities (virtually). The knowledge gained is then incorporated into the selected system variant, which is then realized.

One main task of (computer-implemented) MF simulations is to test various (layout) variants of a planned MF system and of suitable fundamental strategies in advance without realizing each of them. For example, it can be tested whether, at a specific location of the MF or transport network, the utilization of one single transport device of type A (system variant 1) or of two parallel transport devices of type B (system variant 2) were to be better in relation to a desired throughput.

Thus, classic MF simulations are regularly used during the (early) planning phase of the intralogistics system in order to analyze and compare performance of the system variants. Then, the best variant can be selected and realized. In some cases the simulation model created in advance is continuously used so that during plan validation (i.e. upon examining whether the orders can be performed according to the planned manner and order) data from the system is copied again once only and provided to the simulation model, and the simulation model continuous to calculate feasibility based on the assumptions and abstractions made. However, continuous “monitoring” of the simulation run based on the real process of executing the orders is not included.

The above-mentioned timely occurring MF problems (collisions, congestions, wear, slippage, etc.), which arise randomly, thus can be solved neither by the MFC nor by an MF simulation.

The planning and coordination of the MF becomes the more complex for the classic material-flow computer the more the following aspects have to be considered additionally: sequencing; large article assortments; decentralized controlling approaches in departure from the classic central material-flow computer; wear effects; and/or errors in identifying the material-flow objects at decision points.

DE 10 2020 202 945 A1 relates to a storage system and method for operating such storage system.

DE 103 05 344 A1 relates to a system and method for controlling orders of a production device.

Therefore, it is an object of the present disclosure to provide a performant, continuous and resilient material flow in an intralogistics system. Performant material flow is throughput-optimized, wherein the throughput can refer, for example, to a number of transport orders completed per unit of time and/or to a time of performance of a transport order. In a continuous material flow the material-flow objects move continuously without unexpected stoppages, waiting times, blockages, or congestions. A resilient material flow responds flexibly to problems occurring randomly.

This object is solved by an intralogistics system comprising: a transport network comprising a plurality of transport devices and being configured to implement a material flow, caused by transport orders, within the intralogistics system, wherein each of the transport devices is operated with at least one preset variable operating parameter, which preferably can be stored in the transport device and is changeable; a plurality of sensors cyclically detecting current operating states, preferably of the transport devices and/or of the material flow; and a controller including a material-flow computer, which initially plans and generates, preferably once, the transport orders, and cyclically coordinating, preferably by the material-flow computer, the implementation of the transport orders based on the current operating states; the controller further including a digital material-flow twin, which includes a material-flow simulation model, an operating-parameter optimization device, and an analysis device and is configured: to cyclically simulate the material flow based on the respective current operating states, both without and with a plurality of varying operating parameters of the transport devices; to analyze the simulated material flows with regard to throughput improvement; and, in case that throughput improvement is analyzed, to transmit the correspondingly varied operating parameter to the corresponding transport devices, which subsequently are operated based on the varied operating parameters.

Contrary to the classic approach, unexpectedly occurring material-flow problems are not only solved at the point in time at which they actually occur. The problems are not solved with a fixed predefined set of rules either. The problems are anticipated, at an early stage, by the simulation of the material flow without requiring defining precisely the problems themselves. The determination of a deterioration in throughput alone is sufficient in order to become active. The solution lies in the varied operating parameters of the transport devices. The material flow is simulated arbitrarily often during one simulation and optimization cycle for a very large number of different parameter settings based on the continuously observed ACTUAL situation in the warehouse in order to compare the corresponding simulation results to each other, which also include a simulation of the material flow without any parameter modification. A correspondingly simulated material flow is better if it results in a higher throughput than the material flow that was simulated without parameter modification, or if, when predefined throughput values are achieved, there are still everywhere capacity buffers for the handling of possible unexpected events at minimal impact (resilience). Preferably, the simulation runs up to the point in time at which all the transport orders are completed, i.e. all handling units have been moved from the starting point thereof to the destination point thereof.

With other words, the controller of the present disclosure can intuitively identify and solve material-flow problems without, however, predefining the problem and/or the solution. This is a process of continuous improvement.

The material flow of the entire system is analyzed and optimized in a permanently recurring, i.e. cyclical, manner based on current operating states. The optimization is dynamic in contrast to the static (initial) material-flow planning.

Depending on the available computing power, the simulation and optimization cycles can be very short, and the number of varying operating parameters can be selected very large. Ideally, the present disclosure no longer results in any material-flow problems (congestions, delays, collisions, etc.).

The resulting material flow is at least one of performant, continuous, energy-efficient, and resilient.

Preferably, the material-flow computer is configured to: plan, generate, and transmit to the corresponding transport devices initially the transport orders based on picking orders, transport requirements, and/or stock-transfer orders, which, for example, can (also) be input by a warehouse-management system; preferably coordinate the material flow continuously based on the current operating states by implementing, in case of a material-flow problem, a problem solution based on fixed pre-defined solution rules; and receive the operating states from the sensors.

Thus, the material-flow computer used here differs from classic material-flow computers. Hence, the present disclosure can also be applied to existing systems, which are already provided with a classic material-flow computer. In this sense, however, the present disclosure is an extension of existing intralogistics systems. For this purpose, it can already be sufficient to extend the existing system by corresponding controlling software.

Typically, this software extension will also be accompanied by a parallel extension of the hardware (computer). Then, the existing system is capable of reacting dynamically to material-flow problems.

In particular, the transport network includes a plurality of transport sources and a plurality of transport destinations connected to each other via a plurality of transport paths, wherein each of the transport orders defines a handling-unit-specific transport path from one of the sources to one of the destinations. Preferably, the transport orders do not include the operating parameters.

Thus, with the classic material-flow planning, normally the operating parameters are not values which can be varied. The classic planning is performed based on fixed preset parameter values which, however, may include tolerance ranges that in turn are based on empirical values.

Preferably, the throughput improvement results in a higher number of completed transport orders per unit of time in comparison to the material flow simulated based on the respective current operating states without varying operating parameters.

The improvement in throughput actually occurs, even if the throughput actually achieved is worse than an originally planned throughput. This actual throughput is still better than the throughput that would result if the (unexpectedly occurring) material-flow problems were treated with the fixed solution tool only.

In addition, it is advantageous if the correspondingly varied operating parameters, which are to be transmitted to the corresponding transport devices, leave the transport orders unchanged.

Thus, the present disclosure does not plan the material flow (as such) again but changes the initially planned material flow repeatedly by small, sometimes barely noticeable, changes to a better throughput being clearly recognizable at the end. The classic material-flow computer is completely unaware that the material flow is constantly influenced from the outside to the positive, namely by the digital twin of the material flow, due to the variation of the operating parameters of the transport devices.

Preferably, at least some, preferably each, of the transport devices respectively include(s) at least one of the sensors.

In order for the feedback loop to function with the current operating states, it is necessary that the transport devices, which in turn implement the material flow and can be influenced by their operating parameters, report their operating states back to the higher-level controller sufficiently often. Therefore, it is advantageous if the corresponding sensors are directly integrated into the transport devices.

Of course, it is also possible to use sensors detecting the operating states of the material flow and/or of the transport devices from the outside or indirectly. However, in this case the assignment of a detected change in state to the transport device(s) is more complex.

In particular, the transport devices comprise discontinuous conveyors, such as driverless transport systems, SRDs, switches, elevators, transferring devices and the like, and/or continuous conveyors, such as roller conveyors, belt conveyors, chain conveyors, and/or overhead conveyors.

Thus, the present disclosure is applicable to both types of classic conveying devices. The present disclosure is applicable to any conceivable material-flow problem. Thus, the present disclosure is also applicable to any existing system that, as usual, consists of discontinuous and/or continuous conveyors in order to implement the material flow.

Preferably, the intralogistics system comprises a storage and order-picking system, which further comprises at least one of the following functional areas: a warehouse; a goods receipt; a goods issue; a workstation; and/or a production.

The present disclosure is also applicable to all common intralogistics applications. It can be used in the area of intralogistics for production as well as in the classic picking environment (e.g., distribution centers).

Further, the above-mentioned object is solved by a method for improved implementing an initially-planned material flow in an intralogistics system, wherein the intralogistics system comprises: a transport network comprising a plurality of transport devices and being configured to implement a material flow, caused by transport orders, within the intralogistics system, wherein each of the transport devices is operated with at least one preset variable operating parameter, which preferably is storable in the transport device; a plurality of sensors; and a controller including a material-flow computer; wherein the method comprises the steps of: cyclically detecting, by the sensors, current operating states; and initially planning and generating the transport orders as well as cyclically coordinating the generated transport orders by the controller; wherein the controller further includes a digital material-flow twin including a material-flow simulation model, an operating-parameter optimization device, and an analysis device and conducting the following cyclical steps: simulating the material flow based on the respective current operating states with non-varied operating parameters as well as with a plurality of varied operating parameters of the transport devices; analyzing the simulated material flows with regard to throughput improvement; in case that throughput improvement is analyzed, transmitting the correspondingly varied operating parameters to the corresponding transport devices; and operating the corresponding transport devices with the varied operating parameters, in particular upon monitoring the run with the equivalent run of the decision-dominant simulation run.

In this manner, the advantages are realized that have already been discussed above in connection with the intralogistics system.

Preferably, the transport devices are operated with the varied operating parameters without changing the initially planned and generated travelling orders themselves.

The method of the present invention is also applicable in existing systems.

### BRIEF DESCRIPTION OF THE DRAWINGS

It is understood that the features mentioned above, and to be explained below, may not be used in the respective combination only, but also in other combinations or alone, without departing from the scope of the present disclosure.

Examples are shown in the drawings and explained in more detail in the following description.

FIG. 1 shows a block diagram of an intralogistics system being exemplarily implemented as storage and order-picking system.

FIG. 2 shows a block diagram of possible transport devices.

FIG. 3 shows a schematically illustrated transport network.

FIG. 4 shows a plurality of exemplary transport orders in tabular form.

FIG. 5 illustrates functioning of a digital twin.

FIGS. 6A-6B show a first architecture variation (FIG. 6A) and a second architecture variation (FIG. 6B) of a digital material-flow twin.

FIG. 7 shows a flow chart for implementing material flow using a classic material-flow computer.

FIG. 8 illustrates an example of a known material flow.

### DETAILED DESCRIPTION

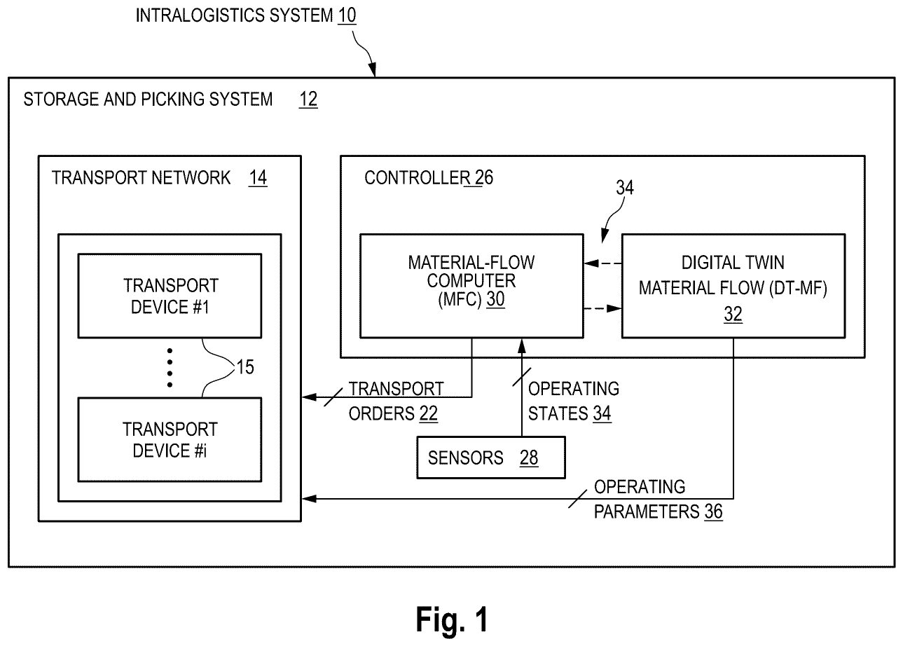

Hereinafter, the term “material flow” (MF) is understood to mean the general term, as defined in the introduction, which is, however, limited substantially to the entirety of all time-dependent local changes (i.e. to the transport movements) of the MF objects (handling units such as storage units, workpieces, conveying items, etc.) caused by transport orders 22. Changes to the MF objects themselves in terms of quantity, quality and/or composition of the MF objects are not considered in detail below for the sake of simplicity of presentation, although they are possible. Each MF object moves in accordance with its transport order 22 from a source to a destination, for which purpose one transport path 24 is selected by a material-flow computer (MFC) 30 typically from a plurality of different transport paths 24, as will be explained in more detail below with reference to FIGS. 1 to 4.

In order to move objects of the MF, i.e. handling units (storage units, conveying items, workpieces, pieces, etc.) through an intralogistics system 10, such as a storage and order-picking system 12, a transport network 14 of multiple transport devices 15 is used, cf. FIG. 1. The transport network 14 is substantially formed of the transport devices 15. There may be transport devices 15 with variable operating parameters 36 and without variable operating parameters 36. The effect of the present disclosure is achieved by the transport devices 15 whose operating parameters 36 are variable.

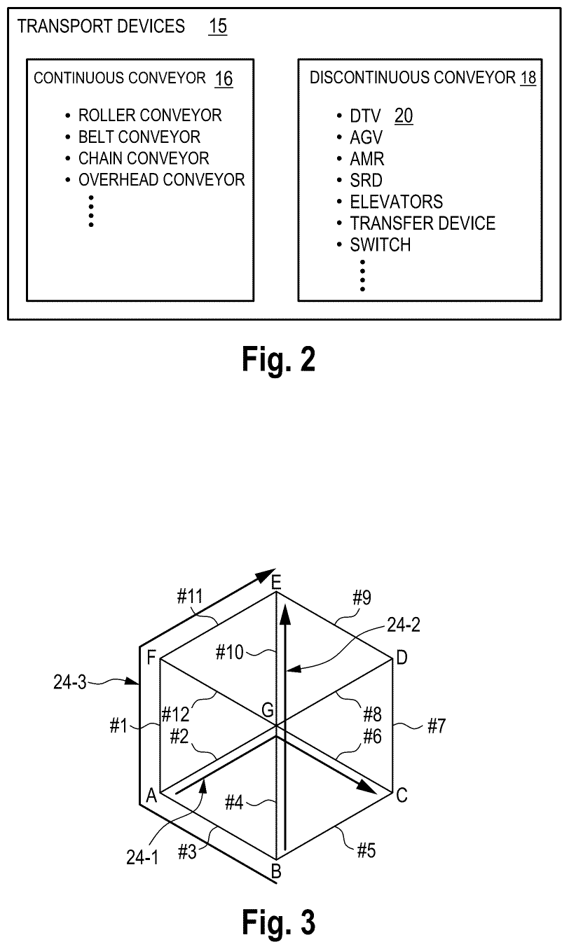

The transport devices 15 are connected to each other for forming a (transport) network 14, cf. also FIG. 3. The transport devices 15 include one or more (modular) continuous conveyors 16, and/or one or more discontinuous conveyors 18, cf. FIG. 2.

The continuous conveyors 16 are operated continuously and are usually installed stationary. They have a high conveying performance, which is measured, for example, in the number of transported handling units per unit of time, and produce a continuous, or quasi-continuous, conveying flow, or MF. The continuous operation and simple function allow good automation and control of the MF in the transport network 14. The corresponding conveyor modules may be formed by roller conveyors, belt conveyors, chain conveyors, overhead conveyors, and/or the like.

The discontinuous conveyors 18 are moveable conveying units, such as driverless transport vehicles (DTVs) 20, which move the handling units from a source to a destination. They can travel to arbitrary points along a line, or in an area or in space. The DTVs 20 are suitable for serving many sources and destinations, for transporting heavy handling units, and for bridging long distances. Depending on the design of the transport network 14, the controlling effort and the requirements for automation also increase with the flexibility of use. The discontinuous conveyors 18 may also include automated (forcibly) guided vehicles (AGVs), autonomous moveable robots (AMRs), classic storage and retrieval devices (SDRs), and the like.

In FIG. 3 one possible implementation of the transport network 14 of FIG. 1 is schematically illustrated. A plurality of points A-G and a plurality of transport routes #1 to #12 are shown, which connect the points A-G to each other. The points A-G may be sources and/or destinations of the MF, which define start and end points of the above-mentioned transport paths 24 consisting of one or more routes. The points A-G may also represent branching and crossing points of the MF. In the digital twin, any transport route exists, which is basically preferred in view of an optimization of the MF. The selection of the situation-dependent optimal conveying path represents a further optimization possibility, besides the adjustment of operating parameters, in the MF.

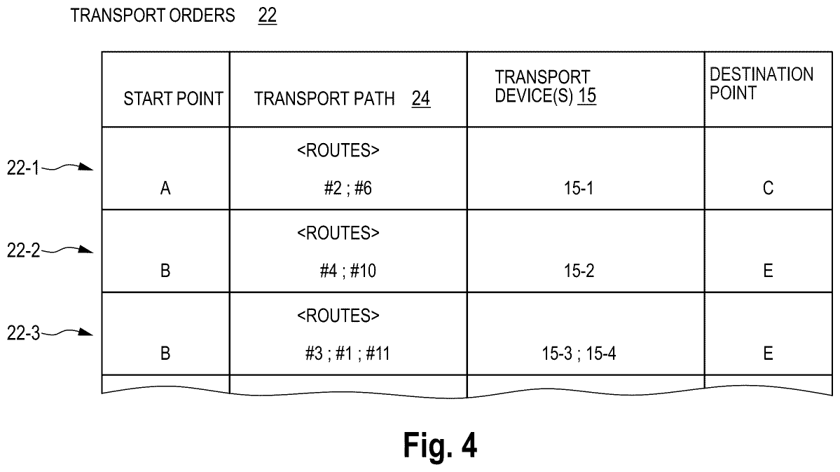

In FIG. 4 exemplary transport orders 22-1 to 22-3 for the network 14 of FIG. 2 are illustrated in tabular form. Each of the transport orders 22 defines a start point, a destination point and a path 24 between these points. Additionally, each of the orders 22 defines a start time and a (calculated, prognosticated) end time. Each of the orders 22 is assigned to one (or more) specific handling units, which is also recorded in the respective order 22. It is understood that the transport orders 22 may include, in addition to the characteristics shown in FIG. 4, one or more of the following information (not shown), such as: the start time, the end time, the ID of the handling unit, prioritization level, and the like, which may be useful for a further specification of a transport order 22.

The transport order 22-1 of FIG. 4 represents an exemplary transport of a handling unit (not shown) from point A (source) to point C (destination) via the routes #2 and #6, wherein this transport is to be conducted by the transport device 15-1, such as by a DTV 20 (cf. FIG. 2). When one of the routes #1 to #12 is implemented by continuous conveyor 16, the related specification of the transport device 15 is not required. However, in this case, for example, transfer times need to be determined and set. The transport orders 22-2 and 22-3 of FIG. 4, which are shown as lines, define two transport paths 24-2 and 24-3, both starting in point B and ending in point E, but extending differently through the network 14 of FIG. 3.

The intralogistics system 10 of FIG. 1 includes, besides the transport network 14, a controller 26 and sensors 28. The controller 26 includes a real (classic) material-flow computer (MFC) 30 (hardware and software) and a digital material-flow twin, i.e. a digital twin of the material flow (DT-MF) 32 (software). The controller 26 is implemented by one or more computers and one or more controlling programs (software). The MF controlling processes, i.e. in particular the coordination of the transport orders 22, can be performed centrally (by the MFC 30) or in a decentralized manner (MFC 30 in combination with, for example, lower-level transport-device controller), namely based on (current) operating states 34 reported back from the sensors 28 to the controller 26, in order to cyclically verify the implementation of the orders 22. The states 34 can be communicated to the MFC 30 and/or to the DT-MF 32, which exchange the states 34 between each other.

The MFC 30 is configured to initially plan and generate the transport orders 22 as well as to continuously coordinate the same, as mentioned above. The transport orders 22 are caused, for example, by picking orders (not shown) in order to retrieve, for example, storage containers (handling units) from their respective storage locations (start point) and transport the same to a work station (destination point), where a person or robot removes stored article from the storage container(s) and delivers the same to an order container (further handling unit), which is transported, in accordance with another transport order 22, also to the work station (temporarily and spatially synchronized). The MFC 30 communicates the initially-generated transport orders 22 to the transport devices 15 involved (and the controllers thereof, if present), which then implement these orders 22 correspondingly, with additional coordination by the MFC 30, if necessary.

The sensors 28 detect, as sensor data, operating states 34 of the MF, of the transport network 14 and of the transport devices 15. Some of the sensors 28 can be provided separately to the transport devices 15, such as centrally positioned cameras in the system 10, which provide 2D images of entire areas (e.g., of the warehouse) from which, by means of image processing, information (occupancy state, traffic density, etc.) on the MF for one or more routes can be extracted. Others of the sensors 28 are directly integrated into the transport devices 15, such as speed, position and distance sensors in the DTV 20, or light barriers, weight sensors and scanners at the entrance/exit of the continuous conveyor 16.

The detected operating states 34 are transmitted by the sensors 28 through correspondingly configured interfaces (including protocols, not shown) to the controller 26 (wired and/or wireless). The sensor data represent input data to the MFC 30 and the DT-MF 32. The sensor data are used for synchronization of the real MF with the simulated material flow, which is cyclically generated by the DT-MF 32.

Exemplary operating states 34 are: occupancy states of the transport devices 15; transport speeds of the transport devices 15; (current) positions of the (moveable) transport devices 15; current motor currents and voltages; current charging states of energy storages; and the like. The operating states 34 change so that they are observed by the controller 26 for enabling reacting situationally in the event of (unexpected) changes.

The DT-MF 32 is configured to virtually or digitally replicate the real MF within the transport network 14 by using a material-flow simulation model (MF-model) 40, as will be explained in more detail below.

In general, digital twins (DTs) are understood to be virtual images of material and/or immaterial objects of the real world. In the present case, one of these objects is the material flow. The virtual images comprise (functional) models, simulations, and/or algorithms, which reproduce the properties and behaviors of the real objects as accurately as possible in the virtual world. The interactions of the objects in reality are becoming increasingly complex. Relationships and dependencies between the objects, as well as effects of their changes, are becoming more and more difficult to assess (in reality). Therefore, the DT is of great importance. The DT allows creating a virtual image of reality. (Parameter) changes to the virtual image can be tested in advance by simulation.

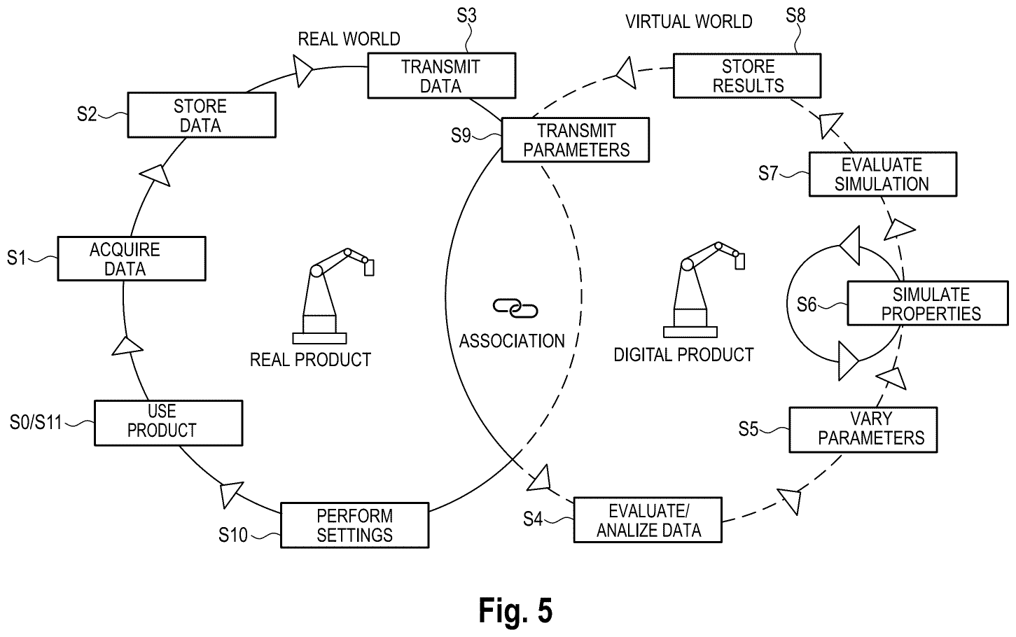

A general goal of using DTs is to simulate optimized new solution approaches, planned changes, and new techniques first in the virtual digital world before they are transferred to the real world. FIG. 5 illustrates the functioning of a classic DT.

In FIG. 5 data caused by real objects, such as a DTV 20 transporting a handling unit from A to B, is detected by sensors in the real world (S1), stored (S2), and then transmitted (S3) by means of an association (interface) to a digital twin, such as to the DT-MF 32 of FIG. 1. In the virtual world, this sensor data can be analyzed and evaluated (S4), for example, by simulating again the material flow based on the transport orders already initially set and the current sensor data (operating states 34 in FIG. 1), wherein the simulation may be performed with the simulation model of the MFC 30 or with any other simulation model. Then, the (operating) parameter 36 are varied (S5) in order to simulate again (S6) the functioning of the virtually mapped object with the respective parameter setting (for each modified parameter). Every possible parameter modification, which may also include a set of modified parameters 36, can thus be simulated in order to subsequently evaluate (S7) the simulation results (with and without parameter variation). For this purpose, the simulation results are analyzed by comparing them with each other and weighting and evaluating them according to one or more given criteria (e.g., increased throughput, shorter throughput time, shorter total processing time, reduced wear, reduced operational costs, more even utilization, lower personal deployment, etc.), in order to determine an optimal parameter setting from the plurality of the simulated parameter settings. These results, and in particular the optimal and optimized parameter setting, can be stored (S8), and the optimal operating parameter(s) 36 are transmitted back (S9), cf. also FIG. 1, by the controller 26, and in particular by the DT-MF 32, via the interface to the real object (transport device 15). The real object takes over the optimized parameter setting (S10) and continues to work (S11) with this setting from now on until it possibly receives in a future cycle a new parameter setting. Subsequently, the above-described process can be repeated from the step S1 on, in order to initiate and implement a process of continuous improvement. The laying eight visualized in FIG. 5 illustrates quite clearly the cyclical optimizing influence on the real world by the DT. It is understood that the demands on the computing power of the DT-MF 32 become the higher the shorter the cycle time is selected and the more parameters 36 per cycle are varied.

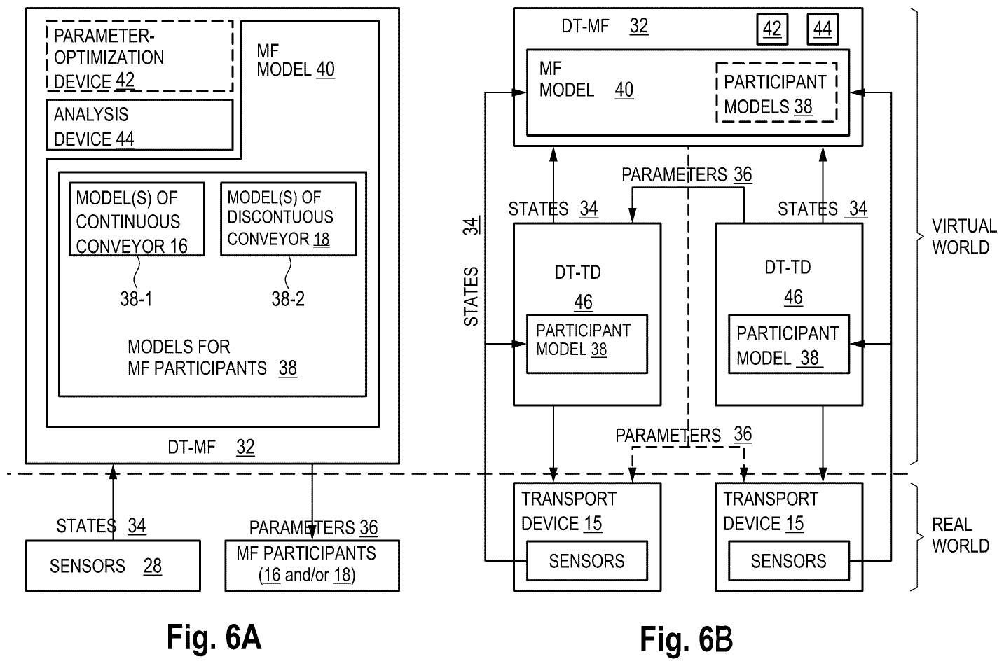

Possible hierarchies of the DT-MF 32 of FIG. 1 are illustrated in more detail in FIGS. 6A and 6B. FIG. 6A shows a first uniform variation and FIG. 6B shows a second distributed variation of DT architecture.

In case of a uniform architecture of the DT-MF 32 in FIG. 6A, the (simulation) models 38 for MF participants (i.e. transport devices 15) are integrated into the MF (simulation) model 40. The participant models 38 include simulation models 38-1 for the real continuous conveyors 16 and/or simulation models 38-2 for the real discontinuous conveyors 18. The MF model 40 simulates the MF by virtually replicating a sequence of transport processes based on the real transport orders 22 of the MFC 30, which are conducted by the transport devices 15, wherein the operating states 34 of the sensors 28 are additionally considered, in order to conduct the above-described parameter-optimization process by means of a parameter-optimization device 42, which is included by the DT-MF 32. The DT-MF 32 further includes an analysis device 44 being configured to execute the step S7. The analysis device 44 compares the different material flows, simulated for different parameters, with the simulated material flow where the parameters are unchanged, and evaluates them from the point of view of an improved throughput. For example, the throughput can be expressed by: an increased number of completed transport orders 22 per unit of time; shorter processing times, i.e. shorter times for completing one order 22; a shorter total processing time, i.e. shorter time for completing all orders 22; a reduced wear, e.g., of a driving motor which is less heavily loaded; reduced operational costs; a more even utilization; a lower personal deployment, and the like.

The same applies to the distributed architecture of FIG. 6B. There, the participant models 38 are included by respective digital participant twins, or digital transport-device twins 46, which are provided separately to the DT-MF 32. The DT-MF 32 and the DTs 46 of the transport devices 15 are provided independent from each other and are functioning independent from each other. The DT-MF 32 simulates the MF based on the MF model 40, which may include, however, even the MF-participant models 38 (identically or in simplified form). In addition, digital twins exist for at least some, and preferably all, of the transport devices 15, i.e. DT-TD 46. The DT-TD 46 simulate the functionalities of their respective transport devices 15 and may bring about—in addition to the throughput—additional performance improvements for the respective transport device 15 by repeatedly optimizing, in the simulation, the operating parameter 36 thereof based on the real operating states 34 provided by the sensors 28 thereof, and evaluating the same under different aspects, in order to use the differently optimized parameter 36 in reality.

In this way, for example, it is possible to monitor the current and voltage behavior of a battery pack of a DTV 20 in order to allow the corresponding model 38 to anticipate above-average discharges due to aging or wear-induced failure of the battery pack. One or more operating parameters 36 of this DTV 20 may be changed, i.e. varied, so that the DTV 20 can be used longer than prognosticated or may be maintained in good time before the anticipated failure. The anticipated failure also represents an operating state 34 that can be communicated to the DT-MF 32, in order to be considered in turn by the DT-MF 32.

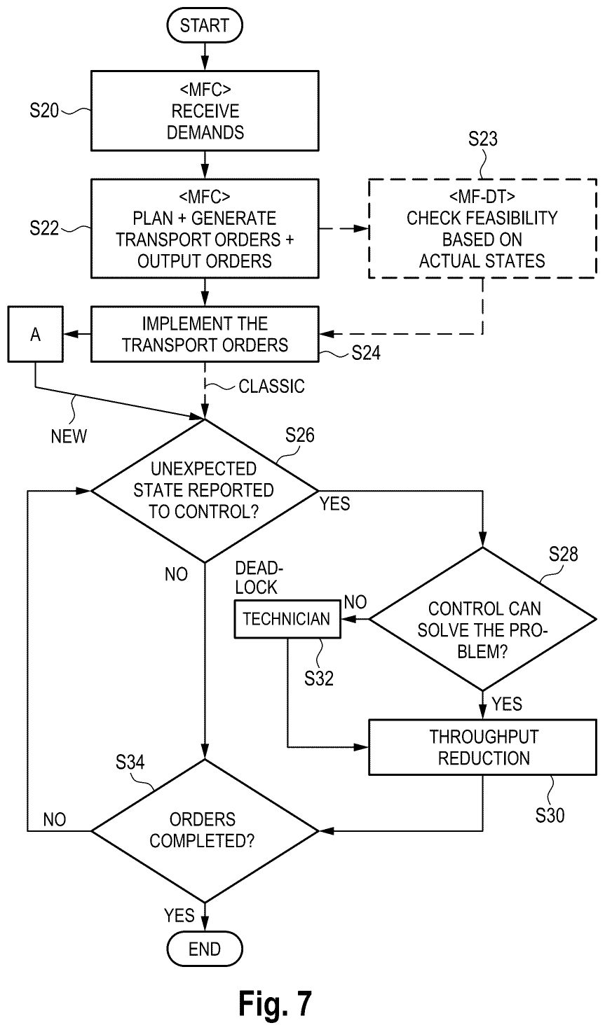

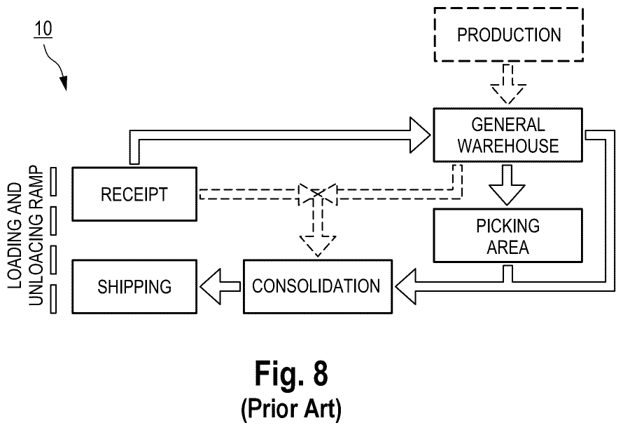

Hereinafter, some examples of unexpectedly occurring problems of the MF are described, which a classic MFC 30 could solve with difficulty only, or not at all, i.e. without the support of the DT-MF 32. For this, it is referred to the flow chart of FIG. 7.

The MFC 30 receives demands (picking orders, stock-transfer orders, transport requirements, etc.) from the outside, such as from picking-order management (not shown) and/or from a warehouse-management system (not shown), cf. step S20. After that, the MFC 30 initially plans and generates the corresponding transport orders 22, if necessary on the basis of a material-flow simulation, which is fed initially and once with the corresponding demands. Upon planning the MFC 30 can use a preset set of operating parameters 36 of the transport devices 15. The MFC 30 determines the transport orders 22, for example, on the basis of currently implemented logics in a throughput-optimized manner, wherein, for this purpose, the MFC 30 may already consider delays that have been gained from experience. The correspondingly generated initial transport orders 22 are communicated to the corresponding transport devices 15, see step S22. Optionally, the correspondingly planned and generated transport orders 22 may be verified, see step 23, regarding feasibility and realizability by the controller 26, in particular by the DT-MF 32, based on actual states 34 (in advance), before the actual implementation is started in step S24.

Then, the transport devices 15 start the implementation of the orders 22 (step S24), which results in the (initially planned) material flow, as long as no unexpected operating state 34 of the material flow and/or the transport devices 15 occurs. Up to this point, the method of the present disclosure does not differ from the classic method.

According to the classic approach, if an unexpected problem spontaneously occurs (for example, a collision may be imminent for two DTVs 20 because one of the DTVs 20 has travelled more slowly than expected; or a conveyor may be unable to deliver its conveying item because the receiving conveyor is occupied, etc.), the associated sensors 26 provide this (unexpected) operating state 34 either directly to the controller 26, or the MFC 30, or to an involved (decentralized) sub-controlling unit (e.g., to the DTV controller or to the conveyor controller), see step 26. If the MFC 30 and/or the sub-controlling unit are capable to solve this problem on the basis of a pre-defined set of rules for possible solutions (e.g.: higher priority has right-of-way; the one having the larger delay may act first, etc.) being unchangeable in themselves, which is checked in step S28 by, for example, reporting back corresponding states 34, there is a de-facto reduction, or deterioration, in throughput (step S30), but there is no serious system failure which can only be solved by a maintenance technician by means of external intervention (step S32). The external intervention represents the last solution option of the pre-known set of rules. The MF is continued until all orders 22 are completed, i.e. ready. Meanwhile, if unexpected operating states 34 occur again, classically some of the steps S26-S32 are performed.

The present disclosure, however, precedes the classic problem-solution approach with the DT-MF 32, see block A and FIG. 5.

The block A of FIG. 7 corresponds to the optimization method of FIG. 5, which uses the DT-MF 32, in order to cyclically find operating parameters 36 for the transport devices 15 involved with the implementation of the MF, which parameters result in a better throughput than the material flow simulated based on the current operating states 34 without any parameter changes in the prognosis.

For example, the digital material-flow twin 32 anticipates the impending collision between the two DTVs 20 and the problem of transfer between the adjacent continuous conveyor 16 long before these conditions actually occur. In the best case, the DT-MF 32 prevents that these states occur in the future. The DT-MF 32 changes the operating parameters (intuitively) within the framework of its parameter optimization, for example, by changing the transport speed of one (or both) of the DTVs 20, or of the feeding continuous conveyor 16 such that there is no collision or delayed delivery. The transport speed in this case represents the variable operating parameter 36. However, the parameter 36 may also be an (alternative) route on the path 24, wherein in this case the transport order 22 itself would be modified. The selection of possible transport devices and parameter settings thereof has no limits. The DT-MF eliminates settings that are not target-oriented, and finds an optimal setting, in particular within the limits of the available computing time and the optimization algorithms used.

Thus, the DT-MF 32 does not prevent the problem by applying pre-defined fixed solutions, but by using (at least) one of the many parameter variations that have proven favorable during the current simulation cycle. Ideally, unexpected operating states 34 are no longer reported back to the controller 26 (step S26) so that the transport orders 22 representing the material flow are completed with a throughput based only on the parameter changes (step S34), which throughput represents a significant improvement compared to an implementation of the initially-planned transport orders 22, even if the throughput actually achieved in this way is worse than the throughput originally estimated during the initial planning.

Of course, despite the block A, there may still be material-flow disruptions which can only be remedied in the classical way. However, the probability of such disruptions is significantly lower than with the classical approach.

Furthermore, it is understood that the above-described effects may also be achieved if the MF is not optimized on the operating parameter 36 in the entire transport network 14, but only in a partial area of the network, such as in a pre-zone of a warehouse. In this case, the conveying system of the pre-zone represents a subsystem of the transport network 14 including the associated transport devices 15. If, among these transport devices 15, there are in turn such whose operating parameters 36 cannot be changed, then only those are optimized whose parameters 36 are variable. Nevertheless, the improved material flow described at the beginning can also be achieved in this case.

### LIST OF REFERENCE NUMERALS

10 intralogistics system
12 storage and order-picking system
14 (transport) network
15 transport device
16 continuous conveyor
18 discontinuous conveyor
20 driverless transport vehicle (DTV)
22 transport order
24 transport path
26 controller
28 sensors
30 material-flow computer (MFC)
32 digital twin of material flow (DT-MF)
34 (operating) states
36 (operating) parameters
38 (simulation) model for MF participants
38-1 continuous-conveyor model
38-2 discontinuous-conveyor model
40 MF (simulation) model
42 parameter-optimization device
44 analysis device
46 digital twin of transport device 15

1-11. (canceled)

12. An intralogistics system comprising:
a transport network comprising a plurality of transport devices and being configured to implement a material flow, caused by transport orders, within the intralogistics system, wherein each of the transport devices is operated with at least one preset variable operating parameter;
a plurality of sensors cyclically detecting current operating states; and
a controller including a material-flow computer, which initially plans and generates the transport orders, and cyclically coordinating the implementation of the transport orders based on the current operating states;
the controller further including a digital material-flow twin, which includes a material-flow simulation model, an operating-parameter optimization device and an analysis device and is configured:
to cyclically simulate the material flow based on the respective current operating states with and without varying operating parameters of the transport devices, wherein the simulation of the material flow reaches up to a point in time at which all of the initially generated transport orders have been completed,
to analyze the simulated material flows with regard to throughput improvement,
and in case that throughput improvement is analyzed, to transmit the correspondingly varied operating parameter to the corresponding transport devices, which subsequently are operated based on the varied operating parameters.

13. The intralogistics system of claim 12, wherein the material-flow computer is configured to:
initially plan and generate the transport orders based on picking orders, transport requirements, and/or stock-transfer orders, and transmit the same to the corresponding transport devices;
continuously coordinate the material flow based on the current operating states by implementing, in case of a material-flow problem, a problem solution based on fixed predefined solution rules; and
receive the operating states from the sensors.

14. The intralogistics system of claim 12, wherein
the transport network includes a plurality of transport sources and a plurality of transport destinations connected to each other via a plurality of transport paths, and
each of the transport orders defines a handling-unit-specific transport path from one of the sources to one of the destinations.

15. The intralogistics system of claim 12, wherein the throughput improvement results in a higher number of completed transport orders per unit of time in comparison to the material flow, which is simulated based on the respective current operating states without varying operating parameters.

16. The intralogistics system of claim 12, wherein the correspondingly varied operating parameters, which are to be transmitted to the corresponding transport devices, leave the transport orders unchanged.

17. The intralogistics system of claim 12, wherein at least some the transport devices respectively include at least one of the sensors.

18. The intralogistics system of claim 12, wherein the transport units include at least one of:
discontinuous conveyors, or
continuous conveyors.

19. The intralogistics system of claim 12, wherein the intralogistics system is a storage and order-picking system further comprising at least one of the following functional areas:
a warehouse;
a goods receipt;
a goods issue;
a work station; or
a production.

20. A method for improved implementing an initially planned material flow in an intralogistics system, which comprises: a transport network comprising a plurality of transport devices and being configured to implement a material flow, caused by transport orders, within the intralogistics system, wherein each of the transport devices is operated with at least one preset variable operating parameter; a plurality of sensors; and a controller including a material-flow computer; wherein the method comprises the steps of:
cyclically detecting, by the sensors, current operating states; and
initially planning and generating the transport orders, as well as cyclically coordinating the generated transport orders by the controller;
wherein the controller further includes a digital material-flow twin, which includes a material-flow simulation model, an operating-parameter optimization device and an analysis device, and conducts the following cyclical steps:
simulating the material flow based on the respective current operating states with non-varied operating parameters as well as with a plurality of varied operating parameters of the transport devices;
analyzing the simulated material flows with regard to throughput improvement;
in case that throughput improvement is analyzed, transmitting the correspondingly varied operating parameters to the corresponding transport devices; and
operating the corresponding transport devices with the varied operating parameters;
wherein the simulation of the material flow reaches up to a point in time at which all of the initially generated transport orders have been completed.

21. The method of claim 20, wherein the transport devices are operated with the varied operating parameters without changing the initially planned and generated travelling orders.

22. The system of claim 17, wherein each of the transport devices respectively includes at least one of the sensors.

23. The system of claim 18, wherein the discontinuous conveyors include driverless transport vehicles.

24. The system of claim 18, wherein the continuous conveyors include at least one of: roller conveyors; belt conveyors; chain conveyors; or overhead conveyors.
